(19) United States
(12) Patent Application Publication
(10) Pub. No.: US 2025/0005532 A1
(43) Pub. Date: Jan. 2, 2025

(54) DETERMINING SKILLS BASED ON MULTIPLE EVALUATORS

(71) Applicant: AstrumU, Inc., Kirkland, WA (US)

(72) Inventors: Xiao Cai, Redmond, WA (US); Feng Zhang, Bellevue, WA (US)

(21) Appl. No.: 18/216,025

(22) Filed: Jun. 29, 2023

(51) Int. Cl. G06Q 10/1053; G06Q 10/0631

(52) U.S. Cl. CPC G06Q 10/1053; G06Q 10/063112

(57) ABSTRACT

Embodiments are directed to managing skill proficiencies by using multiple evaluators to identify overlapping skills. A first job description and a second job description that each respectively describe features of a first job and a second job may be provided. Activities associated with the first job may be determined based on the first job description and activities associated with the second job may be determined based on the second job description. The first activities may be compared with the second activities based on matching models such that each activity that may be included in the first job description and included in the second job description may be considered shared activities. Shared skills may be determined based on the shared activities and may be associated with the job seeker, the first job, the second job, or the like.

### TECHNICAL FIELD

The present invention relates generally to data management, and more particularly, but not exclusively, to managing data for determining skills based on multiple evaluators.

### BACKGROUND

Identifying persons that make good employees has long been a goal of organizations. And, in today's highly competitive global market, finding and keeping great employees is becoming more challenging. Conventionally, organizations may be forced to rely on narrow or limited criteria derived from anecdotal evidence, personal preferences, gut feelings, or the like, rather than evidence based analytics to determine if a person may be a good employee candidate. Often employers seek to match open positions with job seekers using a variety of ad hoc methods, including seeking candidates based on their known skills. However, finding a verifiable mechanism for determining the skills of job seekers or determining how well a candidate's skill may match the skills required for open positions (“jobs”) may be difficult for a variety of reasons. For example, in some cases, employees may fail to provide an accurate lists of their skills—often omitting skills that may match with open positions. Also, relying on official job descriptions of employee work history to determine if their skills match open positions may be disadvantageous because in some cases job descriptions may use different names or labels for the same or overlapping skills. Thus, qualified candidates may be excluded from consideration because of a skill naming mismatch rather than an actual lack of relevant skills. Thus, it is with respect to these considerations and others that the present invention has been made.

### TO DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical architecture of a system for determining skills based on multiple evaluators in accordance with one or more of the various embodiments;

FIG. 5 illustrates a logical representation of skill overlap for determining skills based on multiple evaluators in accordance with one or more of the various embodiments;

FIG. 6 illustrates a logical schematic of a system for determining skills based on multiple evaluators in accordance with one or more of the various embodiments;

FIG. 7 illustrates a logical schematic of a system for determining skills that match between job descriptions based on activity overlap in accordance with one or more of the various embodiments;

FIG. 8 illustrates a logical schematic of a system showing how activities may be matched to skills in accordance with one or more of the various embodiments;

FIG. 9 illustrates an overview flowchart for a process for determining skills based on multiple evaluators in accordance with one or more of the various embodiments;

FIG. 10 illustrates a flowchart for a process for evaluating two job descriptions for determining skills based on multiple evaluators in accordance with one or more of the various embodiments;

FIG. 11 illustrates a flowchart for a process for determining skills based on multiple evaluators in accordance with one or more of the various embodiments; and

FIG. 12 illustrates a flowchart for a process for determining skills based on multiple evaluators in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, Java™, PUP, Perl, Python, JavaScript, Ruby, Rust, Go, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications or can be divided into sub-engines. The engines can be stored in non-transitory computer-readable medium or computer storage devices and be stored on and executed by one or more general purpose computers, thus creating a special purpose computer configured to provide the engine.

As used herein the term “extraction model” refers one or more data structures that encapsulate the data, rules, machine learning models, machine learning classifiers, or instructions that may be employed to determine skill terms or activity terms that may be included in course information. Extraction models may include various components, such as, one or more machine learning based classifiers, heuristics, rules, pattern matching, conditions, or the like, that may be employed to classify terms in raw job description information. The extraction models directed to determining skills may be different from extraction models directed to determining activities.

As used herein the term “matching model” refers one or more data structures that encapsulate the data, rules, machine learning models, machine learning classifiers, or instructions that may be employed to match skill terms or activity terms that may be included in job/training information. Matching models may include various components, such as, one or more machine learning based classifiers, heuristics, rules, pattern matching, conditions, or the like, that may be employed to classify terms in raw job/training description information. Matching models may be used for matching skill terms from job descriptions with skill terms in skill libraries or other job descriptions. Also, matching models may be used for matching activities from different job descriptions. The matching models for matching skills or matching activities may be different matching models.

As used herein the term “job” refers to a specific role or position that an individual performs in exchange for compensation or other consideration. Jobs typically involve a set of tasks, responsibilities, or duties that may contribute to the functioning of an organization, business, or industry. Jobs may vary significantly in terms of skill level, education requirements, working conditions, required skills, or remuneration.

As used herein the terms “job description,” or “job information” refer to a text based narrative that describes skill requirements, education requirements, responsibilities, activities, or the like, associated with one or more jobs, employment opportunities, occupations, or the like. Note, there may be other sources of similar information such as training descriptions, course descriptions, or the like, that describe skills, activities, responsibilities, requirements, or the like, that may be associated with a particular training program or course work. In the interest of brevity or clarity, herein the term job description should be interpreted to generally represent a text description that describes one or more of features, characteristics, responsibilities, skills, activities, or the like, associated with a particular job offering, training course, military occupational specialty, certification program, or the like.

As used herein the term “skill” refers to word, phrases, sentence fragments, that describe an ability that may be performed for a job. In the case of “job descriptions” associated with training materials (rather than jobs), the skills may be phrases sentence fragments, or the like, that a person who completed the training may be expected to be qualified to perform.

As used herein the term “activity” refers to phrases, sentence fragments, sentences, that describe actions that may be performed for a job. In the case of “job descriptions” associated with training materials (rather than jobs), the activities may be phrases sentence fragments, sentences, or the like, that a person who completed the training may be expected to be qualified to perform.

As used herein the term “job profile” refers to one or more data structures or records gathered together to provide information about a job. For example, a job profile may include (or reference) various job description information, required skills, optional skills, or the like.

As used herein the terms “job seeker,” “learner,” or “candidate employee” refer to a person that may have applied to job or a person that may be being considered for a job. Learners may be considered students or trainees while job seekers may be persons seeking a one or more particular jobs.

As used herein the term “declared skill” refers to a skill that is expressly included or identified from job information or job descriptions. In most cases, declared skills may be listed or called out in job information. Often declared skills may be identified in job descriptions or job information using names or labels that may be considered standard or well-known among various industries or government labor agencies, or otherwise included skill libraries, skill indexes, or the like.

As used herein the term “activity skill” refers to a skill that is inferred or implied based on activities described in job information or job descriptions. In most cases, common or well-known names or labels or activity skills are not explicitly listed or called out in job information or job descriptions.

As used herein the term “configuration information” refers to information that may include rule-based policies, pattern matching, scripts (e.g., computer readable instructions), or the like, that may be provided from various sources, including, configuration files, databases, user input, built-in defaults, plug-ins, extensions, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing skill proficiencies by using multiple evaluators to identify overlapping skills. In one or more of the various embodiments, a first job description and a second job description that each respectively describe one or more features of a first job and a second job may be provided such that the first job may be currently held or was previously held by a job seeker.

In one or more of the various embodiments, one or more first activities associated with the first job may be determined based on the first job description and one or more second activities associated with the second job may be determined based on the second job description.

In one or more of the various embodiments, the one or more first activities may be compared with the one or more second activities based on one or more matching models such that each activity that may be included in the first job description and included in the second job description may be considered a shared activity.

In one or more of the various embodiments, in response to determining one or more shared activities based on the comparison, one or more shared skills may be determined based on the one or more shared activities such that the one or more shared skills may be associated with one or more of the job seeker, the first job, the second job, or the like.

In one or more of the various embodiments, one or more first declared skills included in the first job description may be determined based on one or more skill names or one or more skill labels included in the first job description. In one or more of the various embodiments, one or more second declared skills included in the second job description may be determined based on one or more other skill names or one or more other skill labels included in the second job description. In one or more of the various embodiments, the one or more first declared skills may be associated with one or more of the first job or the job seeker. And, in some embodiments, the one or more second declared skills may be associated with the second job.

In one or more of the various embodiments, determining one or more shared activities, may include: generating one or more similarity scores for each of the one or more first activities and the one or more second activities based on the one or more matching models; determining the one or more shared activities based on a portion of the one or more first activities and a portion of the one or more second activities that may be associated with a similarity score that exceeds a threshold value, or the like.

In one or more of the various embodiments, determining the one or more shared skills, may include: determining one or more skill descriptions included in one or more of a skill library, the first job description, the second job description, or the like; generating a similarity score for the one or more skill descriptions or the one or more shared activities based on one or more other matching models; determining the one or more shared skills based on a portion of the one or more skill descriptions and a portion of the one or more shared activities that are associated with a similarity score that exceeds a threshold value; or the like.

In one or more of the various embodiments, one or more first declared skills may be determined based on the first job description. In one or more of the various embodiments, one or more second declared skills may be determined based on the second job description. In one or more of the various embodiments, a number of matched skills may be determined based on a comparison of the one or more first declared skills, the one or more second declared skills, or the one or more shared skills to each other such that each matched skill may be included in the one or more first declared skills, the one or more second declared skills, or the one or more shared skills. In some embodiments, in response to the number of matched skills exceeding a threshold value, indicating that the job seeker is a candidate employee.

In one or more of the various embodiments, a job seeker profile, a first job profile, and a second job profile may be provided. In one or more of the various embodiments, one or more first declared skills may be determined based on the first job description. In one or more of the various embodiments, one or more second declared skills may be determined based on the second job description. In one or more of the various embodiments, the first declared skills may be associated with the job seeker profile and the first job profile. In one or more of the various embodiments, the second declared skills may be associated with the second job profile. In one or more of the various embodiments, the shared skills may be associated with the first job profile, the second job profile, the job seeker profile, or the like.

In one or more of the various embodiments, each first activity, second activity, or shared activity may include, one or more of a word, a phrase, a sentence fragment, a sentence, or the like, that describes one or more actions or responsibilities associated with the first job or the second job.

In one or more of the various embodiments, one or more of the first job description or the second job description, may include a text based narrative description of a job position or training experience that includes one or more of a description of a required skill, a description of an educational requirement, a description of a responsibility of the job position, a description of a skill conferred by the training experience, or the like.

### Illustrated Operating Environment

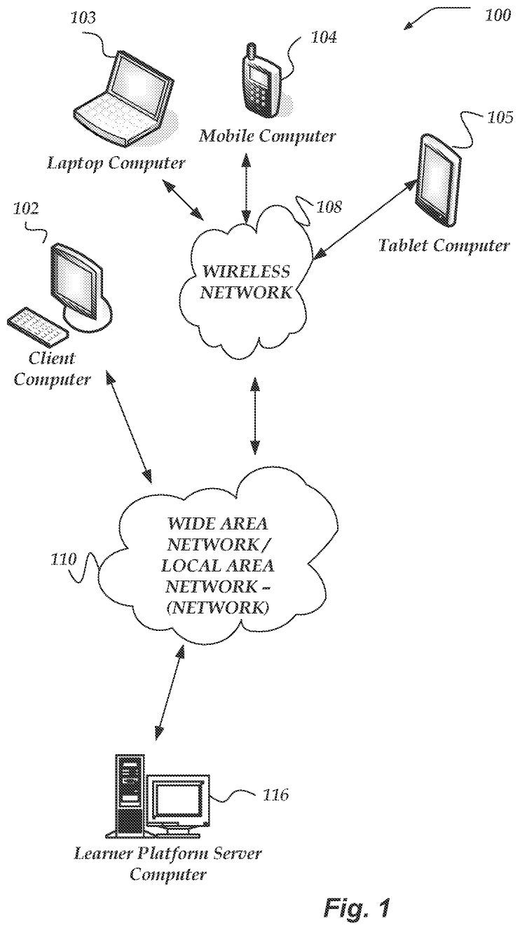

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client computers 102-105, learner platform server computer 116, or the like.

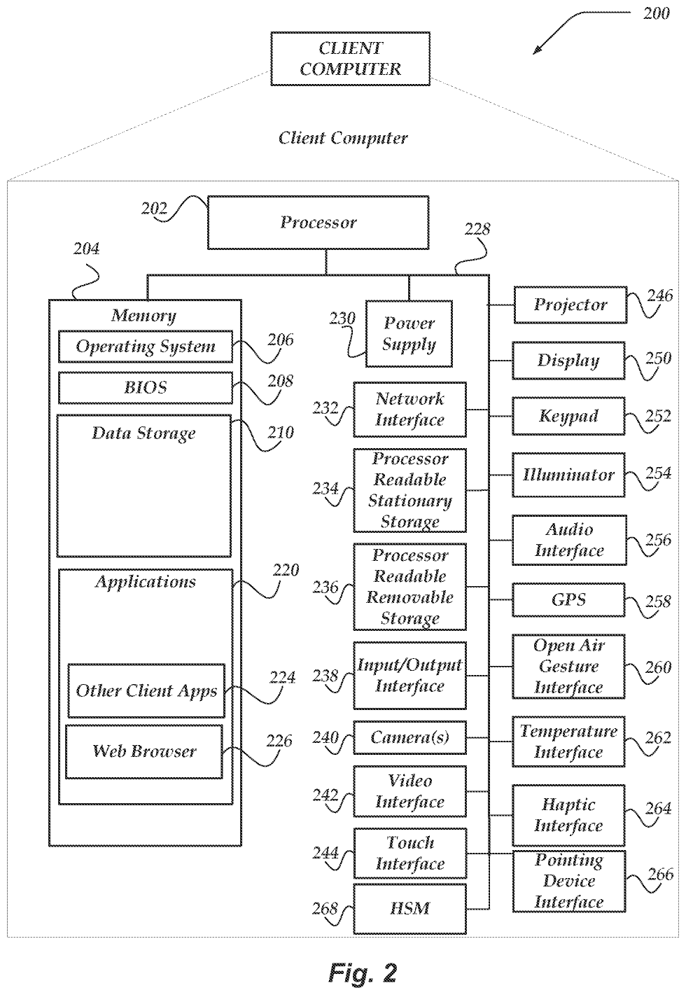

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, learner platform computer 116, or other computers.

Client computers 102-105 may further be configured to include a client application that enables an end-user to log into an end-user account that may be managed by another computer, such as learner platform server computer 116, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by learner platform server computer 116, or the like.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, learner platform server computer 116, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

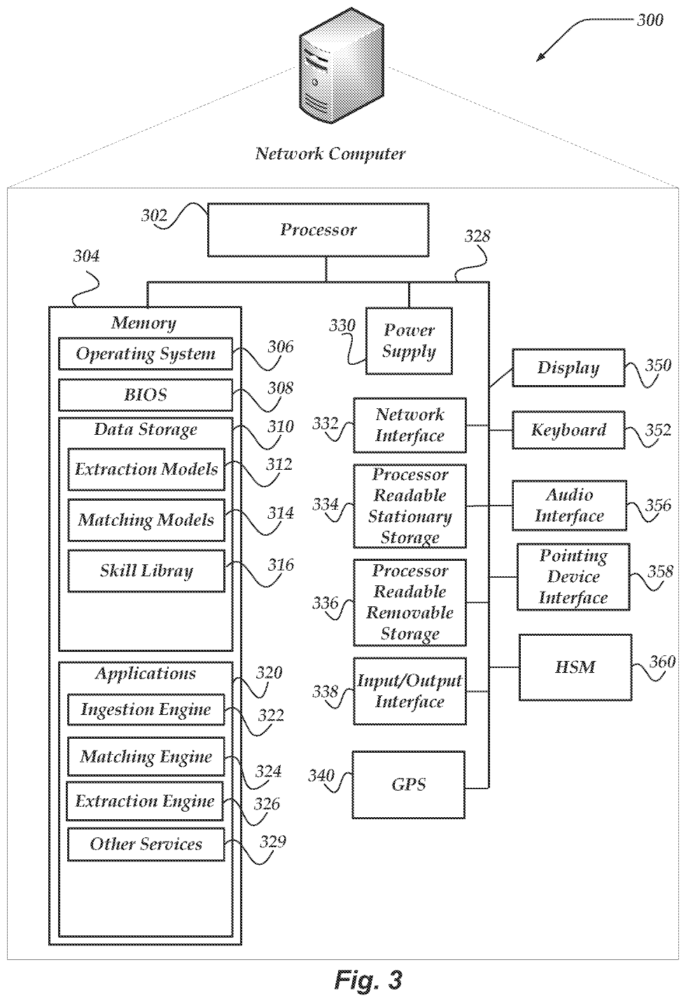

Also, one embodiment of learner platform server computer 116 is described in more detail below in conjunction with FIG. 3. Although FIG. 1 illustrates learner platform server computer 116, or the like, each as a single computer, the innovations or embodiments are not so limited. For example, one or more functions of learner platform server computer 116, or the like, may be distributed across one or more distinct network computers. Moreover, in one or more embodiments, learner platform server computer 116 may be implemented using a plurality of network computers. Further, in one or more of the various embodiments, learner platform server computer 116, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, other client apps 224, web browser 226, or the like, may be arranged to employ geo-location information to select one or more localization features, such as, time zones, languages, currencies, calendar formatting, or the like. Localization features may be used in user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keypad 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over networks implemented using WiFi, Bluetooth™, Bluetooth LTE™, and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or Linux®, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, other client Apps 224, web browser 226, or the like. Client computers may be arranged to exchange communications one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one or more embodiments of a predictive learner server computer such as learner server computer 116, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, ingestion engine 322, matching engine 324, extraction engine 326, other services 329, or the like, may be arranged to employ geo-location information to select one or more localization features, such as, time zones, languages, currencies, currency formatting, calendar formatting, or the like. Localization features may be used in user interfaces, dashboards, reports, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or Linux®, or a specialized operating system such as Microsoft Corporation's Windows® operating system, or the Apple Corporation's MacOS® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, friend lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, extraction models 312, matching models 314, skill library 316, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include ingestion engine 322, matching engine 324, extraction engine 326, other services 329, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, ingestion engine 322, matching engine 324, extraction engine 326, other services 329, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to ingestion engine 322, matching engine 324, extraction engine 326, other services 329, or the like, may be provisioned and de-commissioned automatically.

Also, in one or more of the various embodiments, ingestion engine 322, matching engine 324, extraction engine 326, other services 329, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

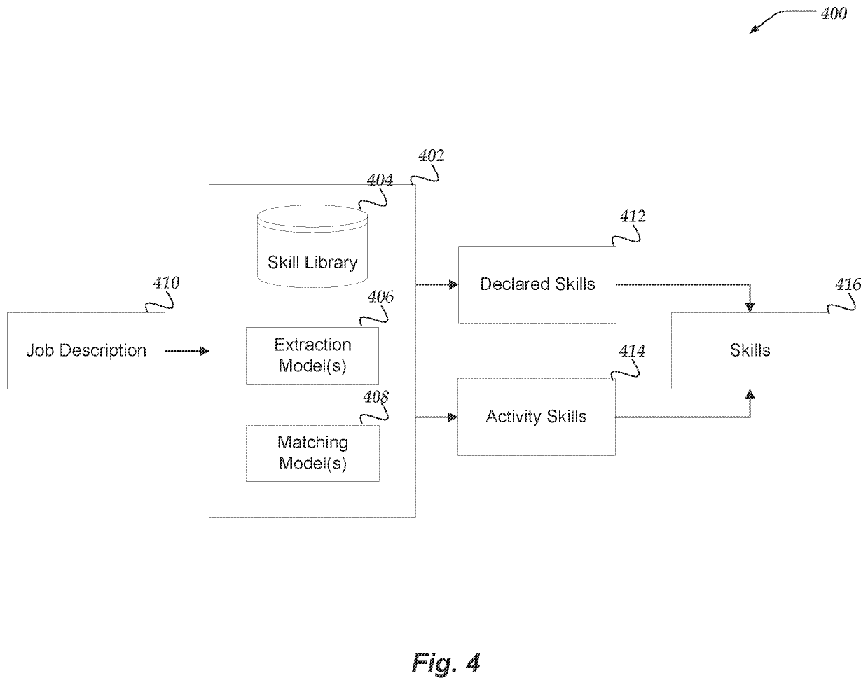

FIG. 4 illustrates a logical architecture of system 400 for determining skills based on multiple evaluators in accordance with one or more of the various embodiments.

In one or more of the various embodiments, organizations seeking to determine if job seekers may qualify for a job may compare the skills required for the job with the skills of the job seeker.

In some cases, an important source of objective job requirements may be found in the official job description for a given job. In some cases, the skills may be explicitly listed. Also, in some cases, the skills may be included in a text narrative that describes the nature of the job or responsibilities associated with the job.

Accordingly, in some cases, organizations may employ automated systems that may identify matches between job seekers and open job positions. Automation may be preferred to enable organizations to efficiently sort through many job seekers to identify candidates that may be suitable for offered jobs.

At least one difficulty with automated matching is reliably or objectively determining the skills of the job seeker based on verifiable information. For example, verifiable information may include confirmed job history information, certifications, licenses, or the like. In contrast, sources, such as, declarations included in resumes or otherwise provided by job seekers may be considered difficult to verify. For example, job seekers may understate the skills or skill levels they have learned from their past jobs or job training. Also, in some cases, job seekers may employ non-standard language to describe their skills or skill levels.

Accordingly, in some embodiments, organizations that seek to use verifiable information to match job seeker skills with available positions may evaluate the skills of job seekers based on formal job descriptions associated with their work history. Likewise, job seeker skills may be discovered or verified based on the information included course descriptions, training programs, or the like.

In some cases, an organization may employ natural language processing to automatically discover skills from job descriptions, training program descriptions, course descriptions, professional certification descriptions, or the like. Accordingly, skills associated with job seekers may be determined based on official/formal descriptions from their past work history or past training history. Thus, an organization may evaluate the quality of match between job seekers and job descriptions based on the job seeker skills and the skills required for the offered jobs.

However, in some cases, source information used for identifying skills may vary greatly in terms of how skills are declared. Also, in some cases, skills may be declared using different labels or naming conventions depending on the source of the job/train description. Also, in some cases, some skills from different industries or training areas may incorporate one or more underlying skills that may overlay underlying skills while not precisely matching. Thus, if job seekers are evaluated just using skills explicitly declared in job information sources (e.g., job descriptions, training course descriptions, or the like), matches among underlying skills may be missed.

In some embodiments, learner platforms may be arranged to identify additional skills in addition to declared skills that may be directly extracted from job/training information narratives. Accordingly, in some embodiments, learner platforms may be arranged to determine skills based on activity information included in the position information narratives. Thus, in some embodiments, learner platforms may be arranged to compare activities languages associated with different declared skills to determine one or more additional skills beyond the declared skills.

In one or more of the various embodiments, learner platforms, such as, learner platform 402 may include a skill library, such as, skill library 404. In some embodiments, skill libraries may be considered to be a database of recognized skills. In some embodiments, skill libraries may be skills declared in government or industry publications. In some embodiments, skill libraries may include names or labels of skill along with other information such as standardized descriptions of the activities or responsibilities associated with a given skill.

In one or more of the various embodiments, learner platforms, such as, learner platform 402 may include one or more extraction models, such as, extraction model(s) 406. In one or more of the various embodiments, extraction models may be rule-based or machine learning based, or a combination thereof. In some embodiments, extraction models may be arranged to process job description information, such as, job description 410 to extract one or more declared skills from job description 410. In this example, for some embodiments, declared skills 412 may be considered to represent a collection of zero or more skills that have be extracted from job description 410. In some embodiments, declared skills may be considered skills that may be explicit named in a job description.

Further, in some embodiments, learner platforms may be arranged to determine one or more activity skills, such as activity skills 414 based on activity text that may be included in job descriptions, such as job description 410. In one or more of the various embodiments, learner platforms may be arranged to infer one or more activity skills based one or more activities that may be included or described in job description. In this example, for some embodiments, activity skills 414 may be considered to represent a collection of zero or more activity skills that have be extracted from job description 410.

Accordingly, in some embodiments, learner platforms may be arranged to provide an improved collected of skills, such as, skills 416 based on declared skills 412 and activity skills 414.

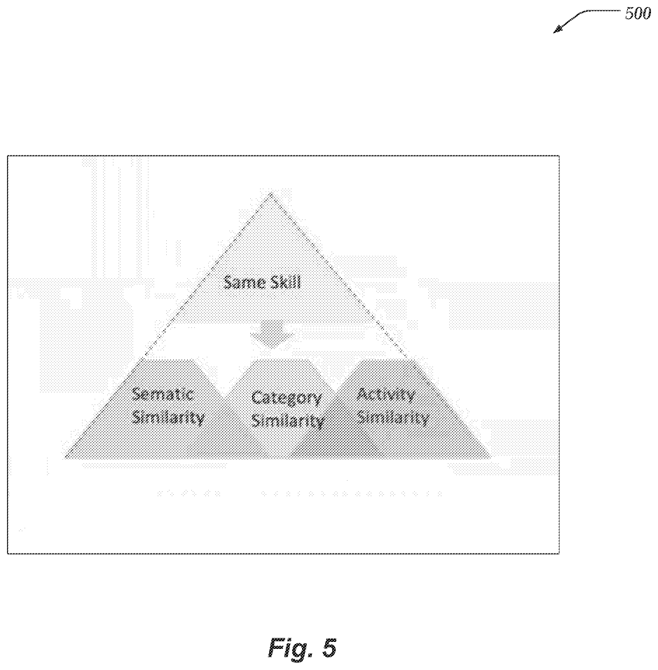

FIG. 5 illustrates a logical representation of skill overlap for determining skills based on multiple evaluators in accordance with one or more of the various embodiments.

In one or more of the various embodiments, extraction engines may be arranged to employ one or more extraction models to determine declared skills from job descriptions. In some embodiments, determining declared skills may be generally considered to be based on conventional NLP methods such as evaluating semantic similarity, category similarity, and so on. Thus, in some embodiments, extraction engines may be arranged to identify skills may map to skills in the skill library using NLP. However, in some embodiments, extraction engines may be configured to employ other extraction models that may be configured to determine activities associated with skills. Accordingly, in some embodiments, activity similarity may be employed to determine activity skills. For example, in some embodiments, skills associated with similar activities may be considered to be similar or the same skill even though the name of the skill as used in job descriptions may be different in different job descriptions. Thus, in some embodiments, extraction engines may be arranged to employ activity similarity to determine if job seeker and job descriptions may be referencing the same skill even though they are named differently in different sources.

Further, in some embodiments, activity similarity may be employed to infer that a job (or training activity) includes a skill that may not be expressly declared.

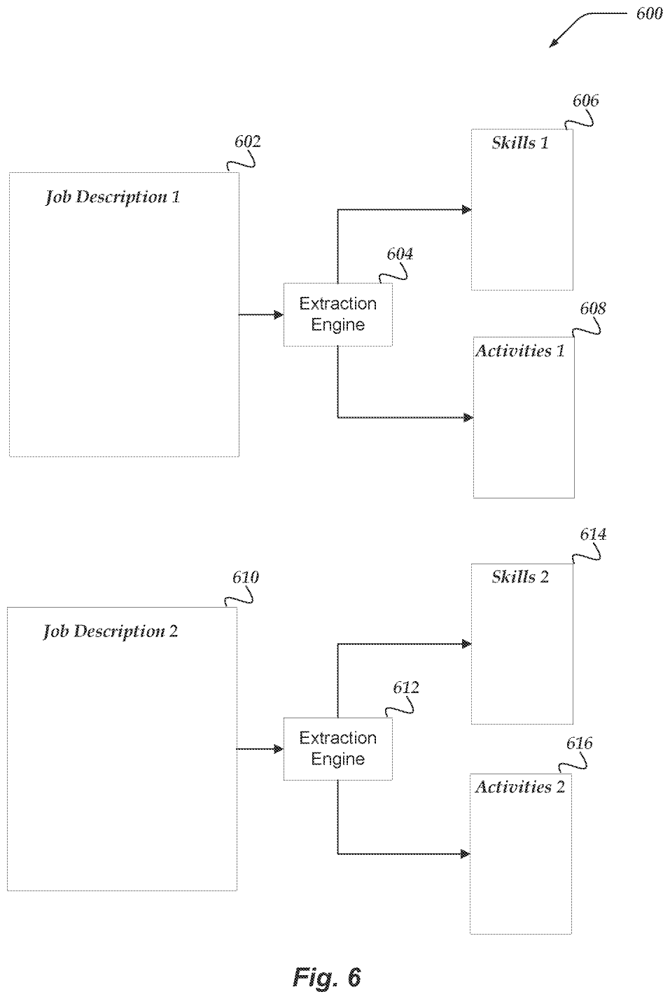

FIG. 6 illustrates a logical schematic of system 600 for determining skills based on multiple evaluators in accordance with one or more of the various embodiments. In this example, system 600 (e.g., a learner platform) may be configured to determine the skills for two different job descriptions to determine if the jobs have one or more overlapping skills. For example, job description 602 may correspond to an open position an organization may be trying to fill. And, in this example, job description 610 may be considered to be a formal job description associated with a job seeker's verified employment history.

Accordingly, in some embodiments, extraction engine 604 may be arranged to employ skill extraction models to determine one or more skills included in job description 602. In this example, skills 606 represents declared skills extracted from the text of job description 602.

Also, in some embodiments, extraction engine 604 may be arranged to employ activity extraction models to determine one or more activities, such as, activities 608 from the text in job description 602.

Similarly, in some embodiments, extraction engine 612 may be arranged to determine skills 614 or activities 616 from job description 610.

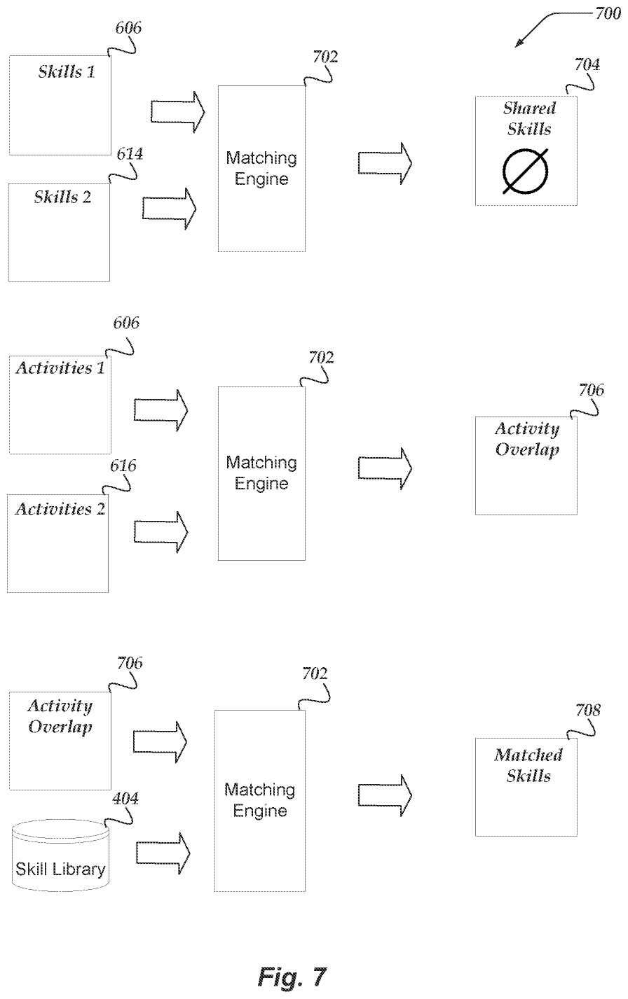

FIG. 7 illustrates a logical schematic of system 700 for determining skills that match between job descriptions based on activity overlap in accordance with one or more of the various embodiments.

In this example, for some embodiments, skills 606 based on job description 602 (not shown) and skills 614 based on job description 610 (not shown) do not have any shared skills. Accordingly, in some embodiments, matching engines, such as, matching engine 702 may generate an empty shared skill collection, such as, shared skills 704.

Accordingly, in this example, if the analysis of a job seeker with skills 614 ended here, it would appear that the job seeker does not have any verifiable skills required for the offered job represented associated with skills 606.

However, in some embodiments, an analysis that compares activities from different job descriptions may determine one or more shared activities that represent activities that may be determined to be in common based on the analysis of the different job descriptions.

Accordingly, in some embodiments, matching engines, such as matching engine 702 may be arranged to compare activities extracted from different job descriptions to determine if the different job descriptions include shared activities. In this example, for some embodiments, activity overlap 706 represents a collection of activities shared between two job descriptions.

In one or more of the various embodiments, matching engines may be arranged to employ matching models that incorporate multiple NLP scoring techniques. Accordingly, in some embodiments, new or different NLP techniques may be introduced by including them in matching models. In some embodiments, different matching models may be developed or tuned for different subject matter or industries. Employing matching models may enable organizations to adapt their activity matching as new or different NLP may be developed. Further, in some embodiments, matching models may be configured to include one or more heuristics that perform additional confirmation checks or sanity checks that may be directed to various subject matter, industries, geographic locations, languages, or the like. Likewise, in some embodiments, matching models may include one or more machine-learning trained classifiers, or the like, that may be trained or adapted for particular locales or subjects. Also, in some embodiments, such machine-learning classifiers may be updated (retrained) if they are determined to begin to skew away from their original training data or initial training scenarios.

In one or more of the various embodiments, matching models may be arranged to employ various NLP methods to determine a similarity score between or among different activity words or activity phrases. In some embodiments, matching models may be arranged to employ more than one NLP comparison that each provide a partial score that may contribute to an overall similarity score. In some embodiments, if similarity scores associated with two or more activities exceed a defined threshold value, the matching engine may report that the two or more compared activities may be similar.

Accordingly, in some embodiments, matching engines may be arranged to periodically test matching models against training data to evaluate the quality of the results predicted by matching models.

For brevity and clarity, a detailed description of matching models, NLP, or the like, used for determining overlapping activities is omitted. However, one of ordinary skill in the art will appreciate that conventional NLP may be employed in addition to one or more specialized/non-standard rules or heuristics that may be included in matching models.

In one or more of the various embodiments, matching engines, such as, matching engine 702 may be arranged to match activities with skills to determine one or more matching skills. Accordingly, in this example, matching engine 702 may be arranged to match activities included in activity overlap 706 with skills from a skill library (e.g., skill library 404) or with skills extracted from the relevant job descriptions to determine one or more matched skills, such as, matched skills 708.

Further, in some embodiments, similar to how matching models may be employed for determining activity overlap, matching engines may be arranged to employ other matching models that are directed to matching activities with skills.

Accordingly, in this example, for some embodiments, even though the declared skills from job description 602 and job description 610 do not match, skills identified based on activity overlap may show that a job seeker may meet the requirements for a job.

Note, in some cases, for some embodiments, extraction engines may determine declared skills that may be shared by different job descriptions. Accordingly, in some embodiments, activity skills determined based on activity language included in job descriptions may supplement shared declared skills to provide an improved understanding of the skills required (or acquired) by a job or training program.

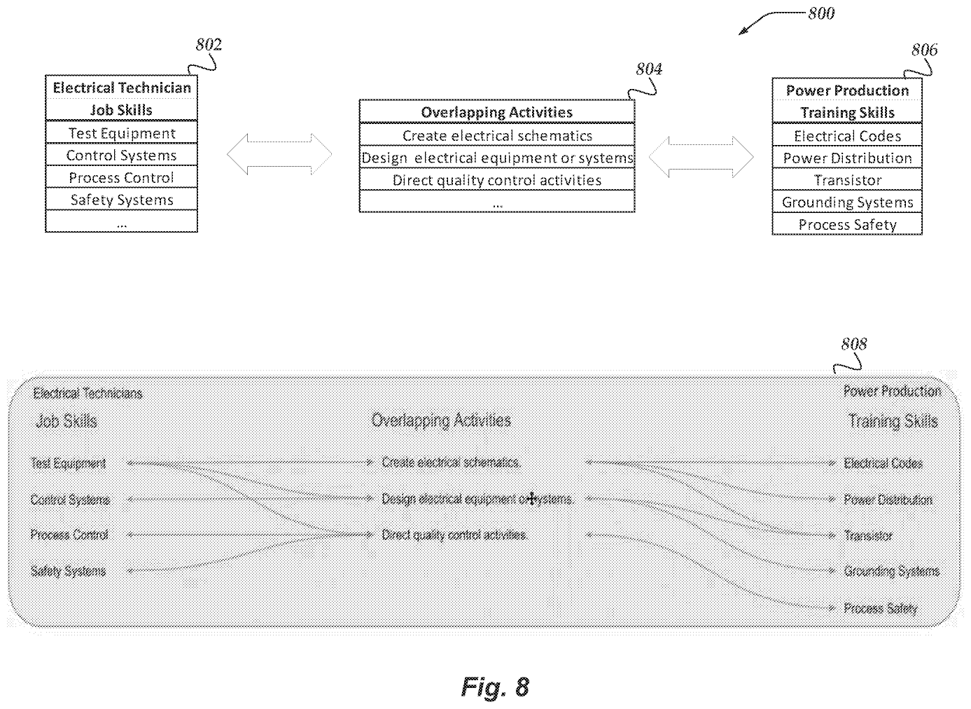

FIG. 8 illustrates a logical schematic of system 800 showing how activities may be matched to skills in accordance with one or more of the various embodiments. As described above, matching engines may be arranged to match activities with skills. Accordingly, in some embodiments, skills that may be associated with the same type of activities may be considered similar skills even though they are named or labeled differently in different job descriptions, training descriptions, course descriptions, or the like.

In this example, for some embodiments: table 802 lists some skills associated with a Electrical Technician jobs; table 804 lists some text fragments that represent activities that may be included in job descriptions; table 806 lists some skills that may be associated with Power Production training course.

In this example, for some embodiments, activity table 804 represents activities that may be associated with one or more skills from both table 802 and table 806 (e.g., overlapped activities). Accordingly, in some embodiments, the overlapped activities may indicate that there are shared skills between the two positions even though the skills themselves are named or labeled differently.

In this example, map 808 shows how the skills in table 802 or table 806 map to the activities in table 804. As described above, in some embodiments, matching engines may be arranged to determine the associations between skills and shared activities.

### Generalized Operations

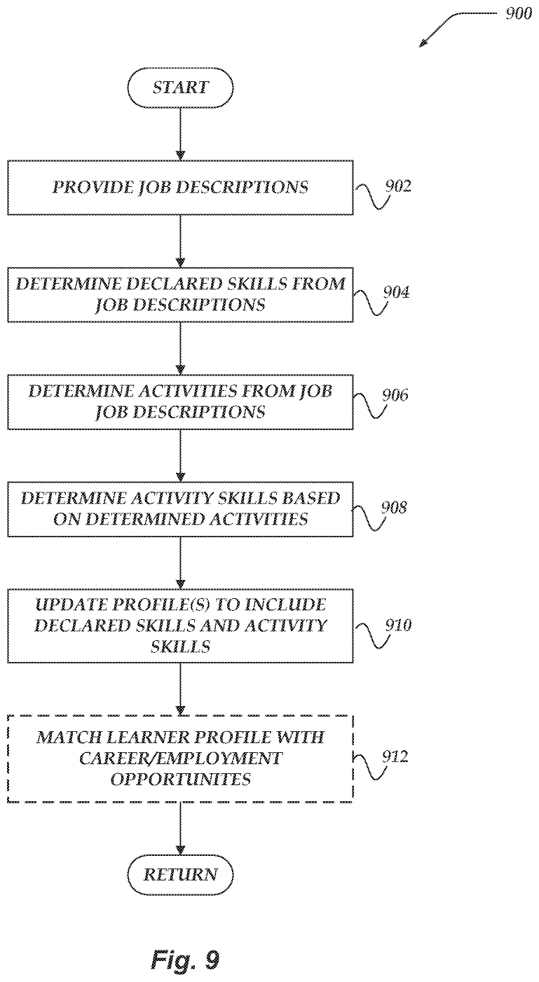

FIGS. 9-12 represent generalized operations for determining skills based on multiple evaluators in accordance with one or more of the various embodiments. In one or more of the various embodiments, processes 900, 1000, 1100, and 1200 described in conjunction with FIGS. 9-12 may be implemented by or executed by one or more processors on a single network computer, such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers, such as, those in a cloud-based environment. However, embodiments are not so limited and various combinations of network computers, client computers, or the like may be utilized. Further, in one or more of the various embodiments, the processes described in conjunction with FIGS. 9-12 may perform actions for determining skills based on multiple evaluators in accordance with at least one of the various embodiments or architectures such as those described in conjunction with FIGS. 4-8. Further, in one or more of the various embodiments, some or all of the actions performed by processes 900, 1000, 1100, and 1200 may be executed in part by ingestion engine 322, matching engine 324, extraction engine 326, or the like.

FIG. 9 illustrates an overview flowchart for process 900 for determining skills based on multiple evaluators in accordance with one or more of the various embodiments. After a start block, at block 902, in one or more of the various embodiments, job information may be provided to a learner platform. Job descriptions (including training descriptions, training course information, academic course information, or the like) may be ingested by learner platforms. In some cases, for some embodiments, learner platforms may be arranged to automatically ingest job descriptions, training descriptions, training course information, academic course information, or the like, that may be provided from organizations offering jobs or training. Note, for brevity or clarity job information, including, job descriptions, training descriptions, training course information, academic course information, or the like, may be referred to as job descriptions.

In one or more of the various embodiments, job descriptions may be formal/official text-based descriptions of skills, activities, responsibilities, or the like, required for a job or provided by training/education. In some cases, job descriptions may be considered to be information put out by organizations offering the job rather than subjective descriptions from former or current job holders, job seekers, or the like. Accordingly, in some embodiments, job descriptions may be expected to include industry standard nomenclature, industry standard skill names/labels, or the like.

In some embodiments, learner platforms may be arranged to employ ingestion engines, such as, ingestion engine 322 to ingest job descriptions from a variety of sources, such as government/labor agencies, help wanted web sites, career services, training centers, organizations listing job offers, or the like. In some cases, learner platforms may be arranged to automatically ingest job descriptions from various sources via APIs or other automated information gathering methods.

At block 904, in one or more of the various embodiments, extraction engines may be arranged to determine one or more declared skills based on the job descriptions.

In one or more of the various embodiments, learner platforms may be arranged to include one or more extraction engines for determining the one or more declared skills that may be included in job descriptions.

In one or more of the various embodiments, extraction engines may be arranged to employ one or more skill extraction models for determining declared skills. As described above, in some embodiments, skill extraction models may be one or more data structures that encapsulate the data, rules, machine learning models, machine learning classifiers, or instructions that may be employed to determine skill terms that may be included in course information. Extraction models may include various components, such as, one or more machine learning based classifiers, heuristics, rules, pattern matching, conditions, or the like, that may be employed to classify terms included in job descriptions.

In one or more of the various embodiments, declared skills may be skills that may be determined directly or inferred directly from the text of job descriptions. In some embodiments, extraction models may be configured to find “skill names” included in job descriptions that match skills in a skill library. Accordingly, in some embodiments, one or more skill extraction models may include rules or regular expressions for matching words or phrases in job descriptions with skills in the skill library. Further, in some embodiments, skill extraction models may be configured to predict that one or more words in a job description may be a skill name using NLP, machine-learning classifiers, heuristics, or the like, or combination thereof.

In some embodiments, extraction engines may be arranged to employ multiple extraction models such that one or more extraction model may be directed to different types of skills, different job description sources, different job description formats, different industries, different organizations, or the like. For example, in some embodiments, a first extraction model may be configured to perform skill word searches while another extraction model may employ NLP in combination with context or document structure to determine skills in job descriptions.

In some embodiments, extraction engines may determine one or more candidate skills that are associated with confidence scores that indicate how well the skill was matched. Accordingly, in some embodiments, extraction engines may be arranged to filter candidate skills based on the confidence score. Accordingly, in some embodiments, skills determined with high confidence scores may be automatically associated with a job profile or user profile. While, in some embodiments, skills associated with lower confidence scores may be flagged for review. Note, confidences scores may be referenced or indicated using other nomenclature, such as “similarity scores” without departing from the scope of these innovations.

Note, in some cases, job descriptions from different industries or different sources may by convention use different names/labels for skills that may be essentially the same skills or skills that have significant overlap.

At block 906, in one or more of the various embodiments, extraction engines may be arranged to determine one or more activities based on the job descriptions. In one or more of the various embodiments, extraction engines may be arranged to employ one or more activity extraction models to determine activities that may be included in a job description.

In one or more of the various embodiments, activities may be phrases of one or more words that correspond to the actual activities a job holder with be expected to perform. Or in the case of training/education description, activities may be one or more words that correspond to activities that a person that completed the training/education would be expected to perform.

At block 908, in one or more of the various embodiments, matching engines may be arranged to determine one or more activity skills based on the determined activities. In one or more of the various embodiments, matching engines may be arranged to employ matching models to determine one or more skills that may be associated with the determined activities.

In one or more of the various embodiments, matching engines may be arranged to associate activities with one or more skills, these skills may be considered activity skills.

In one or more of the various embodiments, matching engines may be arranged to determine one or more shared or overlapping activities such that the overlapped activities are included in more than one job description. Also, in some embodiments, matching engines may be arranged to match one or more activities with skills in a skill library. In some embodiments, in some cases, two or more skills in a skill library (as identified by skill name or skill label) may be associated with the same activities. For example, in some embodiments, skill libraries will include standardized or formalized definitions of skills which may include descriptions of the activities associated with a given skill.

Also, in some embodiments, matching engines may be arranged to determine that two or more job descriptions declare matching or overlapping activities even though the two or more job descriptions do not include matching declared skills. Thus, in some embodiments, a naive or conventional approach may determine that the two job descriptions do not have overlapping/shared skills. For example, for some embodiments, if a job description for a job seeker's prior position is used to determine if the job seeker matches an open position, job seekers' may be excluded from the job opportunity because of the absence of matching declared skills. However, in some embodiments, activity skills associated with job seeker's work history or activity skills associated with the offered job description may indicate that a job seeker that would have been excluded is a qualified candidate.

Further, in some embodiments, learner platforms may be arranged to employ activities to link different skills together based on their shared similarity of activities. Accordingly, in some embodiments, skills that are named or labeled differently even though they correspond to the same or similar activities may be matched. For example, different industries may use different names for skills that are essentially the same. Thus, in some embodiments, matching based on activity similarity enables an improved view of skills.

At block 910, in one or more of the various embodiments, learner platform may be arranged to update job profiles or learner/job-seeker profiles based on the declared skills or the activity skills. Accordingly, in some embodiments, subsequent searches for candidates may consider the activity skills as well as the declared skills.

In some embodiments, learner platforms may enable organizations to determine if job seekers may qualify as a candidate for an open position. Accordingly, in some embodiments, learner platforms may be arranged to determine skills that job seekers may have based on analyzing official/formal (e.g., verifiable) job descriptions from the job seekers' work history, training history, education history, or the like, or combination thereof.

In one or more of the various embodiments, learner platforms may be arranged to process job description information associated with job seekers' employment history to generate an improved view of the skills of individual job seekers. Accordingly, in some embodiments, learner platforms may be arranged to generate job seeker profiles, learner profiles, or the like, that include one or more data structures that include a collection of skills based on verified employment/training/education history. In some cases, job seeker profiles' may include skills comprised of declared skills or activity skills determined from job descriptions associated with verified employment history.

At block 912, in one or more of the various embodiments, optionally, learner platforms may be arranged to match one or more learners or job seekers with one or more employment positions (e.g., jobs) that may be associated with the job descriptions. Accordingly, in some embodiments, learner platforms may be arranged to recommend candidate employees based on matching declared skills and activity skills with the declared skills and activity skills associated with open positions. Likewise, in some embodiments, learner platforms may enable job seekers to evaluate open positions based on comparing declared skills and activity skills of their work history with the declared skills and activity skills determined from job descriptions associated with offered jobs.

Note, this block is indicated as being optional because learner platforms may be configured to employ the declared skills, activity skills, or the like, to update one or more databases associated with skill libraries, job/position libraries, career plans, education plans, or the like.

Next, in one or more of the various embodiments, control may be returned to a calling process.

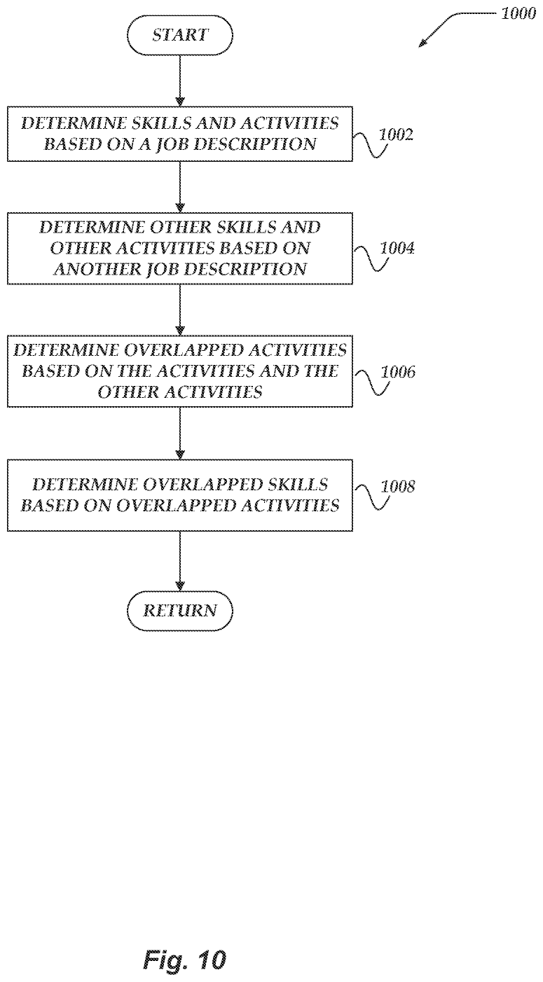

FIG. 10 illustrates a flowchart for process 1000 for evaluating two job descriptions for determining skills based on multiple evaluators in accordance with one or more of the various embodiments. After a start block, at block 1002, in one or more of the various embodiments, learner platforms may be arranged to determine one or more skills or one or more activities based on job information.

As described above, in some embodiments, learner platforms may employ skill extraction models to determine skills directly from job descriptions. These skills may be considered to be declared skills since they may be determined directly from the job description text.

Also, in some embodiments, activities may be one or more word phrases that describe activities associated with performing a job. In some embodiments, one or more activities may be associated with declared skills in the source job description. However, in some embodiments, one or more activities may be determined even though they do not correspond to declared skills. In some cases, for some embodiments, one or more declared skills may be associated with more than one activity.

At block 1004, in one or more of the various embodiments, learner platforms may be arranged to determine one or more other skills or other activities based on other job descriptions. As described above, learner platforms may be arranged to determine other declared skills and other activities from other job descriptions.

Accordingly, in some embodiments, learner platforms may be arranged to determine declared skills and activities from one job description and one or more other declared skills and one or more other activities from another job description.

At block 1006, in one or more of the various embodiments, learner platforms may be arranged to determine one or more overlapped activities based on the activities and the other activities.

In one or more of the various embodiments, learner platforms may be arranged to evaluate how similar the activities associated with one job description may be to other activities associated with another job description.

Accordingly, in some embodiments, matching engines may be arranged to employ one or more matching models to determine similarities scores for the activities from the different job descriptions. In some embodiments, matching models may be configured to user NLP, machine-learning methods, heuristics, or the like, to determine the similarity of activities from the different job descriptions. In some embodiments, different matching models may be employed for different circumstances. For example, in some embodiments, by observation an organization may determine that one or more matching models perform better than others depending on the industry associated with the job descriptions. Also, in some embodiments, while matching models may perform conventional NLP similarity methods, matching models may be modified or updated as different NLP or different machine-learning methods may be applied or discovered. Accordingly, in some embodiments, the particular matching models may be determined based on configuration information to account for local circumstances or local requirements.

At block 1008, in one or more of the various embodiments, learner platforms may be arranged to determine one or more overlapped skills based on the one or more overlapped activities.

In one or more of the various embodiments, matching engines may be arranged to provide a collection of overlapped or shared activities such that shared activities may be those activities that have similarity scores that exceed a configurable threshold value. Note, in some cases, for some embodiments, learner platforms may provide user interfaces that enable users to adjust or modify various matching parameters, including similarity threshold values. Accordingly, in some embodiments, users may be enabled to adjust the threshold value in real-time or during training/tuning exercises.

In one or more of the various embodiments, matching engines may be arranged to determine skills associated with the shared activities. Accordingly, in some embodiments, skills associated with shared activities may be associated with the job descriptions that include the shared activities.

In some embodiments, in some cases, a shared activity may be associated with differently named skills from the different job descriptions that share the same shared activities. For example, in some embodiments, if a first job description is from civilian industry and a second job description is based on a military occupational specialty, if they share the same shared activity, the two separate job description may have shared skills that are named differently based on naming conventions of their respective sources.

Further, in some embodiments, overlapped or shared skills may include one or more skills that are included or considered a sub-skill of another broader skill. For example, if the shared activity is associated with a sub-skill, the shared sub-skills may be determined. Thus, for example, two different job descriptions with different (non-shared) declared skills may have shared sub-skills based on the shared activities.

Next, in one or more of the various embodiments, control may be returned to a calling process.

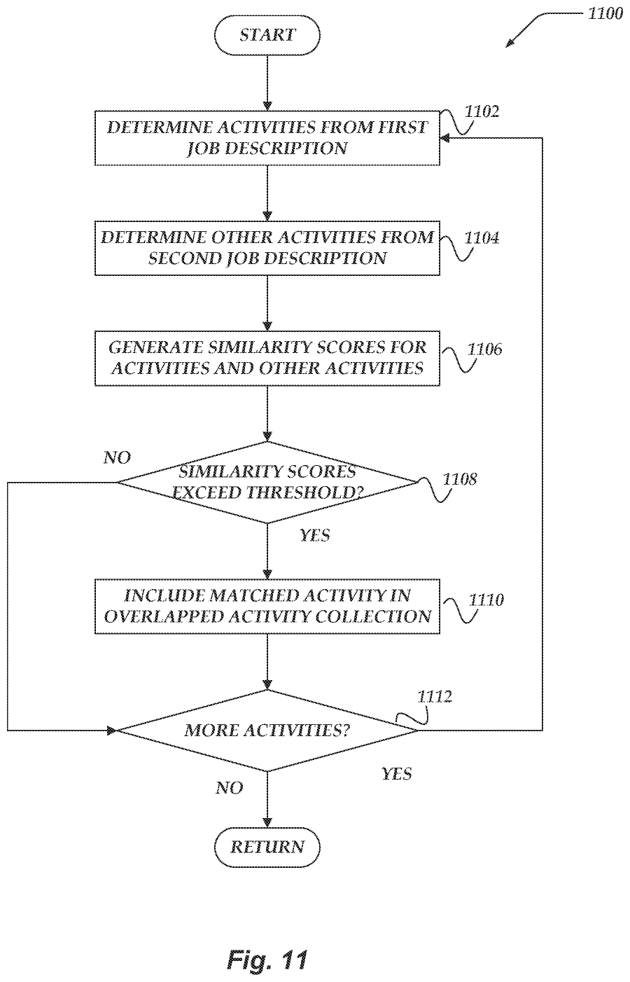

FIG. 11 illustrates a flowchart for process 1100 for determining skills based on multiple evaluators in accordance with one or more of the various embodiments. After a start block, at block 1102, in one or more of the various embodiments, extraction engines may be arranged to determine one or more activities from a job description of a first job. As described above, in some embodiments, extraction engines may be arranged to employ one or more extraction models to determine activity phrases that may be included in job descriptions.

As described above, in some embodiments, extraction models may define one or more heuristics, NLP methods, rules, machine-learning classifiers, other criteria, or the like, that may be employed for determining activities from job descriptions.

Accordingly, in some embodiments, matching engines may be arranged to associate a similarity score with activities that represent their similarity with one or more other activities. In some embodiments, similarity may be comprised of one or more sub-scores each which may be individually weighted by the matching models that produce the scores.

In some embodiments, learner platforms may be arranged to provide one or more user interfaces that enable users to tune or modify matching models (or parameters associated with matching models). Accordingly, in some embodiments, learner platforms may enable user to evaluate matching models or modify matching models. Also, in some embodiments, learner platforms may be arranged to enable users to select or update matching models. Accordingly, in some embodiments, users may be enabled to update matching models based on new or different NLP processes, new or different heuristics, new or different machine-learning classifiers, or the like. Accordingly, in some embodiments, the particular matching models may be determined based on configuration information to account for local circumstance or local requirements.

At block 1104, in one or more of the various embodiments, extraction engines may be arranged to determine one or more other activities from job information for a second job.

At block 1106, in one or more of the various embodiments, matching engines may be arranged to generate one or more similarity scores for the activities and the other activities.

In one or more of the various embodiments, extraction engines may be arranged to generate individual collections of activities for each job based on job descriptions that correspond with the jobs. In some embodiments, activities may be text phrases one or more words that have been identified by extraction models.

In some embodiments, matching engines may be arranged to compare the activities in one or more of different collections to determine similarity between or among the activities in different collections. In some embodiments, matching engines may be arranged to employ matching models that determine the particular heuristics, NLP methods, rules, criteria, or the like, for determining similarity of activities. For example, in some embodiments, matching models may be configured to execute various actions to generate one or more similarity metrics, such as, euclidean distance, dot product, cosine similarity, or the like applied to vectorized forms of the activity phrases. Further, in some cases, heuristics that analyze activity phrases based on larger context, word/string matching, word vector datasets, dictionaries, or the like.

At decision block 1108, in one or more of the various embodiments, if similarity scores associated with exceed a threshold value, control may flow to block 1110; otherwise, control may flow to decision block 1112. In some embodiments, matching engines may be arranged to compare the similarity scores for two or more activities. Activities with similarity scores that exceed the threshold value may be considered similar. The activities from different job descriptions that may be determined similar may be considered shared or overlapped activities such that they are shared between the two or more job descriptions and they may correspond to one or more skills that may have overlap across the two or more job descriptions.

At block 1110, in one or more of the various embodiments, learner platforms may be arranged to include the matched activities in a shared/overlapped activity collection.

In some embodiments, this collection may be used for determining activity skills or shared skills as described herein.

At decision block 1112, in one or more of the various embodiments, if there may be more activities to compare, control may loop based to block 1102; otherwise, control may be returned to a calling process.

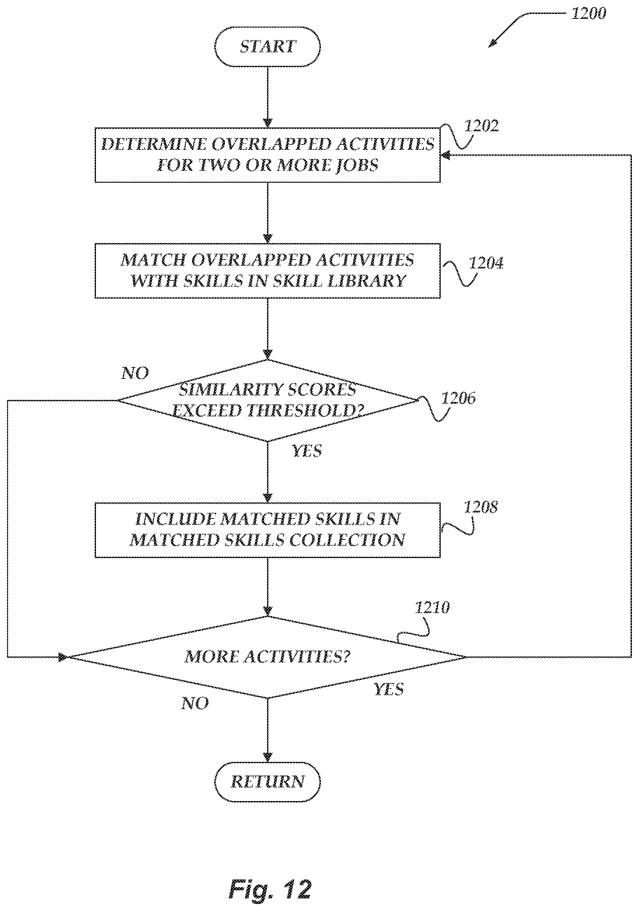

FIG. 12 illustrates a flowchart for process 1200 for determining skills based on multiple evaluators in accordance with one or more of the various embodiments. After a start block, at block 1202, in one or more of the various embodiments, learner platforms may be arranged to determine one or more overlapped/shared activities for two or more jobs. As described above, In some embodiments, matching engines may determine one or more overlapped/shared activities.

At block 1204, in one or more of the various embodiments, matching engines may be arranged to match overlapped activities with one or more skills in a skill library.

In some embodiments, matching engines may be arranged to employ one or more matching models that are directed to mapping activities to skills. Accordingly, in some embodiments, matching models may declare various rules, NLP processes, machine-learning classifiers, heuristics, or the like, for matching the phrases of activities to skills.

In some embodiments, matching engines may be arranged to attempt to match activities with skills from skill libraries. Accordingly, in some embodiments, descriptions associated with skills included in skill libraries may be compared to the activities. In some embodiments, matching models may declare the matching criteria that may be represented by a matching score.

Also, in some embodiments, matching engines may be arranged to attempt to match activities to declared skills in the job descriptions that contributed the activities rather than matching to a separate skill library. Accordingly, in some embodiments, the declared skills included in job descriptions may be associated with the shared activities. In some embodiments, declared skills corresponding to a shared activity from one job description may be considered associated with declared skills included in another job descriptions that correspond to the shared activities. Thus, in some embodiments, the shared activities may provide a link between skills with different names/labels that may be considered similar based on the shared activity.

Accordingly, in some embodiments, matching engines may be arranged to determine as list of skills from skill libraries that match the activities as well as determining a list of declared skills from different job descriptions that may be correlated with each other based on the shared/overlapped activities.

At decision block 1206, in one or more of the various embodiments, if similarity scores associated with skill-activity match exceed a threshold value, control may to block 1208; otherwise, control may flow to decision block 1210.

At block 1208, in one or more of the various embodiments, learner platforms may be arranged to include the one or more matched skills in a matched skill collection.

At decision block 1210, in one or more of the various embodiments, if there may be more overlapped activities, control may loop back to block 1202; otherwise, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

1. A method of managing skill proficiencies over a network using one or more processors to execute instructions that are configured to cause actions, comprising:
training one or more extraction models with raw job description information to determine a first job description and a second job description that each respectively describe one or more features of a first job and a second job, wherein the first job is currently or was-previously held by a job seeker, wherein the one or more extraction models are machine learning models;
training one or more matching models to determine one or more first activities associated with the first job based on the first job description and to determine one or more second activities associated with the second job based on the second job description, wherein the one or more matching models are machine learning models;
employing the one or more matching models to compare the one or more first activities with the one or more second activities, wherein each activity that is included in the first job description and included in the second job description is a shared activity;
employing one or more matching engines to determine one or more shared skills based on an one or more shared activities, wherein the one or more shared skills are associated with one or more of the job seeker, the first job, or the second job;
retraining the one or more matching models with testing data for each shared activity included in the first and second job descriptions, wherein the one or more retrained matching models are employed to determine one or more activity overlap parameters for an activity collection of the one or more shared activities;
employing the one or more matching engines and the one or more retrained matching models to add one or more matched skills to a skill collection based on similarity scores for a plurality of matching activity overlap parameter comparisons for the activity collection that include one or more skills extracted from the first and second job descriptions compared to one or more other job descriptions relevant to the first and second job descriptions and further compared to a library of predetermined skills, wherein each label associated with each of the one or more extracted skills are named differently than each label associated with each of the one or more shared skills;
generating a job recommendation for a candidate job seeker based on a comparison of the one or more matched skills and the one or more shared skills in the skill collection to a profile for the candidate job seeker that includes one or more of a declared skill or a determined activity skill; and
generating a user interface for the candidate job seeker to modify in real time one or more activity overlap parameter comparison thresholds, wherein the one or more modifications are used for another job recommendation for the candidate job seeker.

2. The method of claim 1, further comprising:
determining one or more first declared skills included in the first job description based on one or more skill names or one or more skill labels included in the first job description; and
determining one or more second declared skills included in the second job description based on one or more other skill names or one or more other skill labels included in the second job description;
associating the one or more first declared skills with one or more of the first job or the job seeker; and
associating the one or more second declared skills with the second job.

3. The method of claim 1, wherein determining one or more shared activities, further comprises:
generating one or more similarity scores for each of the one or more first activities and the one or more second activities based on the one or more matching models; and
determining the one or more shared activities based on a portion of the one or more first activities and a portion of the one or more second activities that are associated with a similarity score that exceeds a threshold value.

4. The method of claim 1, wherein determining the one or more shared skills, further comprises:
determining one or more skill descriptions included in one or more of a skill library, the first job description, or the second job description;
generating a similarity score for the one or more skill descriptions and the one or more shared activities based on one or more other matching models; and
determining the one or more shared skills based on a portion of the one or more skill descriptions and a portion of the one or more shared skills that are associated with a similarity score that exceeds a threshold value.

5. The method of claim 1, further comprising:
determining one or more first declared skills based on the first job description;
determining one or more second declared skills based on the second job description;
determining a number of matched skills based on a comparison of the one or more first declared skills, the one or more second declared skills, and the one or more shared skills to each other, wherein each matched skill is included in the one or more first declared skills, the one or more second declared skills, or the one or more shared skills; and
in response to the number of matched skills exceeding a threshold value, indicating that the job seeker is a candidate employee.

6. The method of claim 1, further comprising:
providing a job seeker profile, a first job profile, and a second job profile;
determining one or more first declared skills based on the first job description;
determining one or more second declared skills based on the second job description;
associating the first declared skills with the job seeker profile and the first job profile;
associating the second declared skills with the second job profile and the job seeker profile; and
associating the shared skills with the first job profile, the second job profile and the job seeker profile.

7. The method of claim 1, wherein each first activity, second activity, or shared activity, further comprises, one or more of a word, a phrase, a sentence fragment, or a sentence that describes one or more actions or responsibilities associated with the first job or the second job.

8. The method of claim 1, wherein one or more of the first job description or the second job description, further comprise, a text based narrative description of a job position or training experience that includes one or more of a description of a required skill, a description of an educational requirement, a description of a responsibility of the job position, or a description of a skill conferred by the training experience.

9. A network computer for managing skill proficiencies over a network, comprising:
a memory that stores at least instructions; and
one or more processors that execute the instructions that are configured to cause actions, including:
training one or more extraction models with raw job description information to determine a first job description and a second job description that each respectively describe one or more features of a first job and a second job, wherein the first job is currently or was-previously held by a job seeker, wherein the one or more extraction models are machine learning models;
training one or more matching models to determine one or more first activities associated with the first job based on the first job description and to determine one or more second activities associated with the second job based on the second job description, wherein the one or more matching models are machine learning models;
employing the one or more matching models to compare the one or more first activities with the one or more second activities, wherein each activity that is included in the first job description and included in the second job description is a shared activity;
employing one or more matching engines to determine one or more shared skills based on one or more shared activities, wherein the one or more shared skills are associated with one or more of the job seeker, the first job, or the second job;
retraining the one or more matching models with testing data for each shared activity included in the first and second job descriptions, wherein the one or more retrained matching models are employed to determine one or more activity overlap parameters for an activity collection of the one or more shared activities;
employing the one or more matching engines and the one or more retrained matching models to add one or more matched skills to a skill collection based on similarity scores for a plurality of matching activity overlap parameter comparisons for the activity collection that include one or more skills extracted from the first and second job descriptions compared to one or more other job descriptions relevant to the first and second job descriptions and further compared to a library of predetermined skills, wherein each label associated with each of the one or more extracted skills are named differently than each label associated with each of the one or more shared skills;
generating a job recommendation for a candidate job seeker based on a comparison of the one or more matched skills and the one or more shared skills in the skill collection to a profile for the candidate job seeker that includes one or more of a declared skill or a determined activity skill; and
generating a user interface for the candidate job seeker to modify in real time one or more activity overlap parameter comparison thresholds, wherein the one or more modifications are used for another job recommendation for the candidate job seeker.

10. The network computer of claim 9, wherein the one or more processors execute instructions that are configured to cause actions that perform actions, further comprising:
determining one or more first declared skills included in the first job description based on one or more skill names or one or more skill labels included in the first job description; and
determining one or more second declared skills included in the second job description based on one or more other skill names or one or more other skill labels included in the second job description;
associating the one or more first declared skills with one or more of the first job or the job seeker; and
associating the one or more second declared skills with the second job.

11. The network computer of claim 9, wherein determining one or more shared activities, further comprises:
generating one or more similarity scores for each of the one or more first activities and the one or more second activities based on the one or more matching models; and
determining the one or more shared activities based on a portion of the one or more first activities and a portion of the one or more second activities that are associated with a similarity score that exceeds a threshold value.

12. The network computer of claim 9, wherein determining the one or more shared skills, further comprises:
determining one or more skill descriptions included in one or more of a skill library, the first job description, or the second job description;
generating a similarity score for the one or more skill descriptions and the one or more shared activities based on one or more other matching models; and
determining the one or more shared skills based on a portion of the one or more skill descriptions and a portion of the one or more shared skills that are associated with a similarity score that exceeds a threshold value.

13. The network computer of claim 9, wherein the one or more processors execute instructions that are configured to cause actions that perform actions, further comprising:
determining one or more first declared skills based on the first job description;
determining one or more second declared skills based on the second job description;
determining a number of matched skills based on a comparison of the one or more first declared skills, the one or more second declared skills, and the one or more shared skills to each other, wherein each matched skill is included in the one or more first declared skills, the one or more second declared skills, or the one or more shared skills; and
in response to the number of matched skills exceeding a threshold value, indicating that the job seeker is a candidate employee.

14. The network computer of claim 9, wherein the one or more processors execute instructions that are configured to cause actions that perform actions, further comprising:
providing a job seeker profile, a first job profile, and a second job profile;
determining one or more first declared skills based on the first job description;
determining one or more second declared skills based on the second job description;
associating the first declared skills with the job seeker profile and the first job profile;
associating the second declared skills with the second job profile and the job seeker profile; and
associating the shared skills with the first job profile, the second job profile and the job seeker profile.

15. The network computer of claim 9, wherein each first activity, second activity, or shared activity, further comprises, one or more of a word, a phrase, a sentence fragment, or a sentence that describes one or more actions or responsibilities associated with the first job or the second job.

16. The network computer of claim 9, wherein one or more of the first job description or the second job description, further comprise, a text based narrative description of a job position or training experience that includes one or more of a description of a required skill, a description of an educational requirement, a description of a responsibility of the job position, or a description of a skill conferred by the training experience.

17. A processor readable non-transitory storage media that includes instructions for managing skill proficiencies over a network, wherein execution of the instructions by one or more processors performs actions, comprising:
training one or more extraction models with raw job description information to determine a first job description and a second job description that each respectively describe one or more features of a first job and a second job, wherein the first job is currently or was-previously held by a job seeker, wherein the one or more extraction models are machine learning models;
training one or more matching models to determine one or more first activities associated with the first job based on the first job description and to determine one or more second activities associated with the second job based on the second job description, wherein the one or more matching models are machine learning models;
employing the one or more matching models to compare the one or more first activities with the one or more second activities, wherein each activity that is included in the first job description and included in the second job description is a shared activity;
employing one or more matching engines to determine one or more shared skills based on one or more shared activities, wherein the one or more shared skills are associated with one or more of the job seeker, the first job, or the second job;
retraining the one or more matching models with testing data for each shared activity included in the first and second job descriptions, wherein the one or more retrained matching models are employed to determine one or more activity overlap parameters for an activity collection of the one or more shared activities;
employing the one or more matching engines and the one or more retrained matching models to add one or more matched skills to a skill collection based on similarity scores for a plurality of matching activity overlap parameter comparisons for the activity collection that include one or more skills extracted from the first and second job descriptions compared to one or more other job descriptions relevant to the first and second job descriptions and further compared to a library of predetermined skills, wherein each label associated with each of the one or more extracted skills are named differently than each label associated with each of the one or more shared skills;
generating a job recommendation for a candidate job seeker based on a comparison of the one or more matched skills and the one or more shared skills in the skill collection to a profile for the candidate job seeker that includes one or more of a declared skill or a determined activity skill; and
generating a user interface for the candidate job seeker to modify in real time one or more activity overlap parameter comparison thresholds, wherein the one or more modifications are used for another job recommendation for the candidate job seeker.

18. The media of claim 17, further comprising:
determining one or more first declared skills included in the first job description based on one or more skill names or one or more skill labels included in the first job description; and
determining one or more second declared skills included in the second job description based on one or more other skill names or one or more other skill labels included in the second job description;
associating the one or more first declared skills with one or more of the first job or the job seeker; and
associating the one or more second declared skills with the second job.

19. The media of claim 17, wherein determining one or more shared activities, further comprises:
generating one or more similarity scores for each of the one or more first activities and the one or more second activities based on the one or more matching models; and
determining the one or more shared activities based on a portion of the one or more first activities and a portion of the one or more second activities that are associated with a similarity score that exceeds a threshold value.

20. The media of claim 17, wherein determining the one or more shared skills, further comprises:
determining one or more skill descriptions included in one or more of a skill library, the first job description, or the second job description;
generating a similarity score for the one or more skill descriptions and the one or more shared activities based on one or more other matching models; and
determining the one or more shared skills based on a portion of the one or more skill descriptions and a portion of the one or more shared skills that are associated with a similarity score that exceeds a threshold value.

21. The media of claim 17, further comprising:
determining one or more first declared skills based on the first job description;
determining one or more second declared skills based on the second job description;
determining a number of matched skills based on a comparison of the one or more first declared skills, the one or more second declared skills, and the one or more shared skills to each other, wherein each matched skill is included in the one or more first declared skills, the one or more second declared skills, or the one or more shared skills; and
in response to the number of matched skills exceeding a threshold value, indicating that the job seeker is a candidate employee.

22. The media of claim 17, further comprising:
providing a job seeker profile, a first job profile, and a second job profile;
determining one or more first declared skills based on the first job description;
determining one or more second declared skills based on the second job description;
associating the first declared skills with the job seeker profile and the first job profile;
associating the second declared skills with the second job profile and the job seeker profile; and
associating the shared skills with the first job profile, the second job profile and the job seeker profile.

23. The media of claim 17, wherein each first activity, second activity, or shared activity, further comprises, one or more of a word, a phrase, a sentence fragment, or a sentence that describes one or more actions or responsibilities associated with the first job or the second job.

24. The media of claim 17, wherein one or more of the first job description or the second job description, further comprise, a text based narrative description of a job position or training experience that includes one or more of a description of a required skill, a description of an educational requirement, a description of a responsibility of the job position, or a description of a skill conferred by the training experience.

25. A system for managing skill proficiencies, comprising:
a network computer, comprising:
a memory that stores at least instructions; and
one or more processors that execute the instructions that are configured to cause actions, including:
training one or more extraction models with raw job description information to determine a first job description and a second job description that each respectively describe one or more features of a first job and a second job, wherein the first job is currently or was-previously held by a job seeker, wherein the one or more extraction models are machine learning models;
training one or more matching models to determine one or more first activities associated with the first job based on the first job description and to determine one or more second activities associated with the second job based on the second job description, wherein the one or more matching models are machine learning models;
employing the one or more matching models to compare the one or more first activities with the one or more second activities, wherein each activity that is included in the first job description and included in the second job description is a shared activity;
employing one or more matching engines to determine one or more shared skills based on one or more shared activities, wherein the one or more shared skills are associated with one or more of the job seeker, the first job, or the second job;
retraining the one or more matching models with testing data for each shared activity included in the first and second job descriptions, wherein the one or more retrained matching models are employed to determine one or more activity overlap parameters for an activity collection of the one or more shared activities;
employing the one or more matching engines and the one or more retrained matching models to add one or more matched skills to a skill collection based on similarity scores for a plurality of matching activity overlap parameter comparisons for the activity collection that include one or more skills extracted from the first and second job descriptions compared to one or more other job descriptions relevant to the first and second job descriptions and further compared to a library of predetermined skills, wherein each label associated with each of the one or more extracted skills are named differently than each label associated with each of the one or more shared skills;
generating a job recommendation for a candidate job seeker based on a comparison of the one or more matched skills and the one or more shared skills in the skill collection to a profile for the candidate job seeker that includes one or more of a declared skill or a determined activity skill; and
generating a user interface for the candidate job seeker to modify in real time one or more activity overlap parameter comparison thresholds, wherein the one or more modifications are used for another job recommendation for the candidate job seeker; and
a client computer, comprising:
a memory that stores at least instructions; and
one or more processors execute the instructions that are configured to cause actions, including:
providing one or more of the first job description or the second job description.

26. The system of claim 25, wherein the one or more network computer processors execute instructions that are configured to cause actions that perform actions, further comprising:
determining one or more first declared skills included in the first job description based on one or more skill names or one or more skill labels included in the first job description; and
determining one or more second declared skills included in the second job description based on one or more other skill names or one or more other skill labels included in the second job description;
associating the one or more first declared skills with one or more of the first job or the job seeker; and
associating the one or more second declared skills with the second job.

27. The system of claim 25, wherein determining one or more shared activities, further comprises:
generating one or more similarity scores for each of the one or more first activities and the one or more second activities based on the one or more matching models; and
determining the one or more shared activities based on a portion of the one or more first activities and a portion of the one or more second activities that are associated with a similarity score that exceeds a threshold value.

28. The system of claim 25, wherein determining the one or more shared skills, further comprises:
determining one or more skill descriptions included in one or more of a skill library, the first job description, or the second job description;
generating a similarity score for the one or more skill descriptions and the one or more shared activities based on one or more other matching models; and
determining the one or more shared skills based on a portion of the one or more skill descriptions and a portion of the one or more shared skills that are associated with a similarity score that exceeds a threshold value.

29. The system of claim 25, wherein the one or more network computer processors execute instructions that are configured to cause actions that perform actions, further comprising:
determining one or more first declared skills based on the first job description;
determining one or more second declared skills based on the second job description;
determining a number of matched skills based on a comparison of the one or more first declared skills, the one or more second declared skills, and the one or more shared skills to each other, wherein each matched skill is included in the one or more first declared skills, the one or more second declared skills, or the one or more shared skills; and
in response to the number of matched skills exceeding a threshold value, indicating that the job seeker is a candidate employee.

30. The system of claim 25, wherein each first activity, second activity, or shared activity, further comprises, one or more of a word, a phrase, a sentence fragment, or a sentence that describes one or more actions or responsibilities associated with the first job or the second job.
